(19) United States
(12) Patent Application Publication
(10) Pub. No.: US 2010/0043346 A1
(43) Pub. Date: Feb. 25, 2010

(54) Shutter fastener system and method of installation

(76) Inventor: Alfred C. Lancer, New Milford, CT (US)

Correspondence Address: TED PAULDING, 10 PENWOOD LA,, WETHERSFIELD, CT, 06109, US

(21) Appl. No.: 12/229,710

(22) Filed: Aug. 25, 2008

(51) Int. Cl. E06B 3/30

(52) U.S. Cl. 52/784.1

(57) ABSTRACT

A shutter and fastener system comprising a shutter and two or more fastener mechanisms each comprising cooperating latching and anchor devices, one device mounted on an edge portion of the shutter and the other on an adjacent trim portion. The latching device engages the anchor device and exerts a strong pulling force substantially parallel with the surface of the shutter. The anchor device converts a portion of this force to a perpendicular force resulting in firm engagement between the shutter and the trim portion. An installation method comprises the steps of proving a shutter with a t least one latching device mounted thereon and a small opening in the shutter aligned with operating means for the device. An anchor device is provided on an adjacent trim portion and the operating means is actuated from inside the shutter though the small opening to secure the shutter in place. A hanger means for the shutter may also be provided and the need for a ladder in an elevated installation is obviated by passing the shutter outwardly through an opening and thereafter actuating one or more latching devices from within the structure.

Hurricane shutters comprising sheets of plywood or more complex metallic or plastic members have in the past been fastened in place by various means ranging from simple nails and screws to complex multi-part fasteners. While generally satisfactory none of the various fastening means has been found completely satisfactory.

Accordingly, it is the general object of the present invention to provide an improved shutter and fastener system which can be installed in position over a window or the like with a minimum expenditure of time and effort and which is of desirably simple construction and yet provides a superior result in securing shutters firmly in position against adjacent trim.

A further object of the invention resides in the provision of a fastener system and a method of shutter and fastener installation which can be carried out without the use of a ladder for elevated windows etc.

A still further object resides in the provision of a one man installation method which can be carried out from the inside of a window or the like.

### RELATED PATENTS

U.S. Pat. No. 3,309,115 to Alfred C. Langer, Mar. 16, 1964 entitled MECHANISM FOR REMOVABLY SECURING PANELS discloses fastener mechanisms which may be adapted to use in the present invention as does U.S. Pat. No. 3,844,832 also to Alfred C Lander, Oct. 23, 1967 and entitled FASTENER MEANS. Both patents are hereby incorporated herein by reference.

### SUMMARY OF THE INVENTION

In accordance with the present invention and in fulfillment of the foregoing objects, a shutter is provided to cover an opening such as a window, door etc. and has at least two spaced apart edge portions with window trim or the like adjacent thereto. Conventionally, rectangular shutters are of course employed and may be simple sheets of plywood, more complex metallic shutters etc. At least two fastener mechanisms are preferably provided each comprising latching and anchor devices. One device is mounted on an edge portion of a shutter and the other on an adjacent trim portion, four (4) fastener mechanisms usually being provided in a rectangular arrangement when a rectangular shutter is employed. Neither the latching nor the anchor device projects beyond the edge of the shutter when the fastener mechanism is in its unlatched condition. In the latched condition of the mechanism, however, the latching device spans the shutter edge, engages the anchor device and exerts a strong latching force therebetween substantially parallel to the face of the shutter. Further, a means on one of said devices exerts a force perpendicular to the shutter and in the direction urging the shutter firmly against its adjacent trim.

In the preferred form of the invention the perpendicular shutter closing force is derived from the parallel latching force by means on one of the devices which simultaneously converts a portion of the latching force to the desired perpendicular force directed toward the trim of the window or the like.

The fastener mechanisms are preferably of the type disclosed in the aforementioned patents but may vary widely in design and construction. In all cases, however, the fasteners exert a perpendicular force urging the shutter into firm engagement with the trim. Even a slight degree of looseness between a shutter and its adjacent trim may of course result in the shutter being vibrated, torn loose, and blown away by the excessively high winds encountered in a hurricane.

As disclosed in the aforementioned patents and in the present invention the latching device includes a generally S shaped spring-like latching element which in its unlatched condition resides wholly on one side of a shutter edge but which in its latched condition projects outwardly and spans the shutter edge to engage its corresponding anchor device with a strong but resilient locking force parallel to the face of the shutter. An eccentric actuator for the latching element causes a hook at the free end of the S shaped member to first swing down into engagement with the anchor device and then to pull on the device with a resilient retractive force as high as 500 pounds. Conversion of a part of this force to a resultant perpendicular force is accomplished by means of an inclined surface on the anchor device and, more particularly, an inclined internal edge surface of a slotted receiver member for the S shaped latching element/

Preferably, manual operating means for the latching devices are provided on both the front and rear surfaces thereof with conventional sockets presently preferred and shown in the drawings.

The installation method of the invention comprises the steps of providing a shutter with at least one latching device mounted thereon near an edge so as to project beyond the edge in a latching operation. The latching device has a rearwardly exposed manual operating means and the shutter is provided with a small through opening aligned with the operating means. An anchor device on adjacent trim co-operates with the latching device as aforesaid. The shutter is positioned over a window or the like and the operating means is accessed through the small opening from the rear side of the shutter and actuated to cause the device to engage the anchor device and thus secure the shutter in place. As will be apparent a one man procedure may be followed with the installer passing the shutter diagonally outwardly through an open window and then securing the same in place as aforesaid.

This procedure can of course also be followed on elevated windows etc. avoiding the need for a ladder. Finally, for convenience co-operating vertical support means may be provided to hold the shutters temporarily while latching devices are engaged with anchor devices for secure mounting of the shutters.

### DESCRIPTION OF THE DRAWINGS

FIG. 1 of the drawings is a somewhat schematic front view of a shutter carrying four (4) latching devices in accordance with the present invention,

FIG. 2 is an enlarged front view of a single latching device and a single anchor device in a latched condition, the unlatched condition being shown in broken line form.

FIG. 3 is an enlarged side view of engaged latching and anchor devices in a surface mounting arrangement,

FIG. 4 is an enlarged side view of engaged latching and anchor devices in a flush mounting arrangement, and

FIG. 5 is a perspective view of a fastener mechanism with a hinged anchor device,

FIG. 6 is a perspective view of a pair of fastener mechanisms and a batten connecting adjacent shutters.

FIG. 7 is a top view of the fastener mechanism of FIG. 5, and

FIG. 8 is top view similar to FIG. 6 but with the fastener and anchor devices in reversed positions, and

### DESCRIPTION OF PREFERRED EMBODIMENT

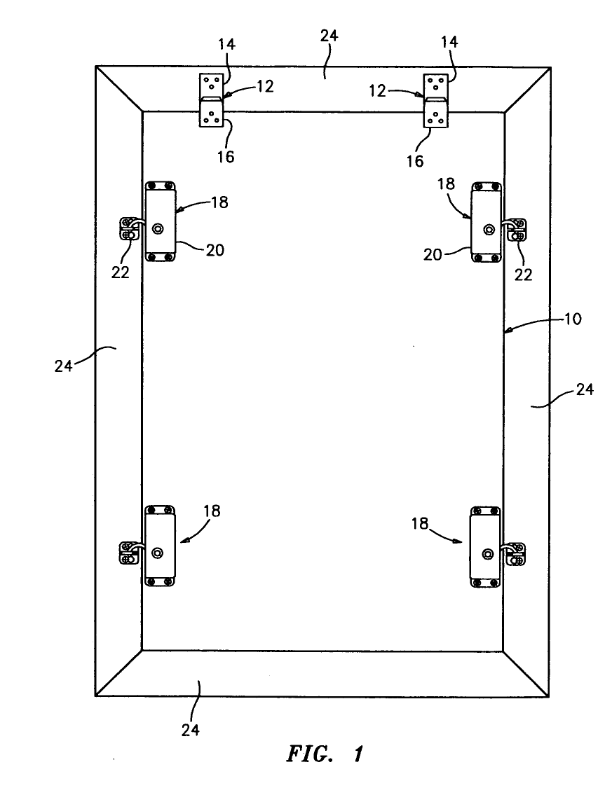

Referring particularly to FIG. 1, a hurricane shutter is indicated generally at 10 and may comprise a conventional 4×8 ft. sheet of plywood of appropriate thickness. The shutter is shown supported on co-operative vertical support means 12, 12 which may comprise simple hanger devices with an upper part 14 attached to window trim or the like and a lower part 16, attached to an upper portion of the shutter.

As will be obvious, the shutter 10, can be hung in position from outside the structure on hangers 12, 12 over a window requiring protection from hurricane winds. As will also be obvious, the shutter can be hung from inside the structure with the window open, the shutter being passed outwardly through the window in a diagonal attitude and thereafter held in position by the hangers 12, 12.

In accordance with the invention, at least one fastener mechanism is provided for securing the shutter in place. As shown, four (4) fastener mechanisms 18, 18 are shown in a rectangular arrangement corresponding to the corresponding configuration of shutter 10. Each fastener mechanism 18 includes a latching device 20 and an anchor device 22, the former shown mounted on the shutter and the latter on an adjacent trim or frame portion 24 associated with a window or the like. Alternatively, and with a possible reversal of the slot angle in the anchor device, the latching devices 20, 20 may be located on the trim portion 24 with the anchor devices 22, 22 mounted on the shutter. As shown in FIG. 3, a surface mounting arrangement may be employed with the shutter 10 overlapping the trim portion 24 and engaging the outer surface 26 thereof. Alternatively, the shutter 10 can be flush mounted as illustrated in FIG. 4 by providing a small recess such as that shown at 28 or simply fitting the shutter within the frame with small metal or wood stop members provided to establish the appropriate depth of the shutter.

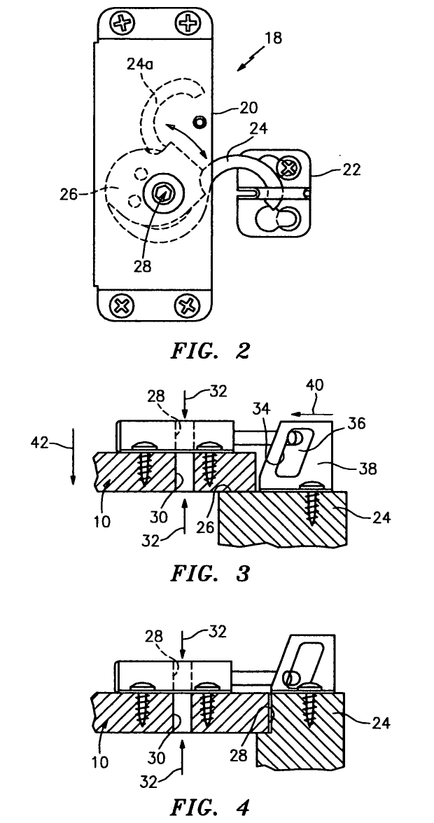

Referring now to FIGS. 2, 3 and 4 and the aforementioned patents, each fastener mechanism 18 includes a latching device 20 as aforesaid with a generally S shaped latching element 24 of spring metal controlled by an eccentric 26 and an operating means 28 which may be in the form of a conventional hexagonal socket exposed both at the front and rear surfaces of the latching device. A conventional hexagonal operating tool may be provided or, alternatively, a small handle may be provided for manual manipulation. As best illustrated in FIGS. 3 and 4, a small opening 30 provided in the shutter 10 and aligned with the socket 28 accommodates actuation of the socket from the rear of the latching device. Arrows 32, 32 illustrate the multi-directional operation of the latching device. On rotation of the socket 28 in a clockwise direction in FIG. 2, the latching element 24 moves from the broken line retracted position 24a to the operative position shown in FIGS. 2-4. In the FIGS. 2-4 position latching element 24 engages an inner surface 34 of a slot 36 in a receiver 38 which forms a part of the anchor device 22. Due to the eccentricity of the element 26, the free end portion of the latching element 24 exerts a retractive or pulling force indicated by the arrow 40 in a direction substantially parallel with the surface of the shutter 10. This force may be in the neighborhood of 500 lbs and the spring characteristics of the latching element compensate for dimensional errors and, more importantly, enables the shutter to withstand heavy vibration caused by the high winds. As aforesaid, the inclined surface 34 in the slot 36 serves to convert a portion of the parallel force 40 to a perpendicular force 42 urging the shutter into firm engagement with the trim portion 24. The slot 36 is dimensioned to accommodate plywood or the like one-fourth to three-fourths of an inch in thickness.

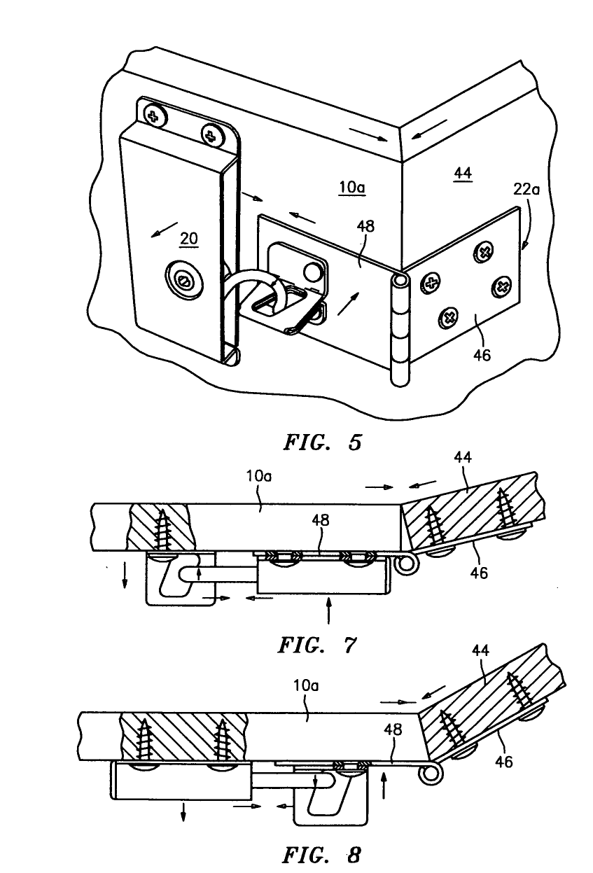

Referring to FIGS. 5, 7 and 8, a shutter 10a is shown associated with an adjacent member 44 which make take the form of a right angularly arranged second shutter or a trim portion. To accommodate this arrangement, a conventional latching device 20 may be employed with a hinge-like anchor device 22a. A first part 46 of the anchor device maybe secured to the member 44 with a second part 48 positioned on the surface of the shutter 10a adjacent the latching device 20, or vice versa. The part 48 may be identical with the anchor device 22 of FIGS. 2 and 3 and operation of the fastener mechanism may also be identical with that described above. With the hinge element 46 shown, various angles other than ninety degrees between the shutter 10 and the member 44 may of course be accommodated.

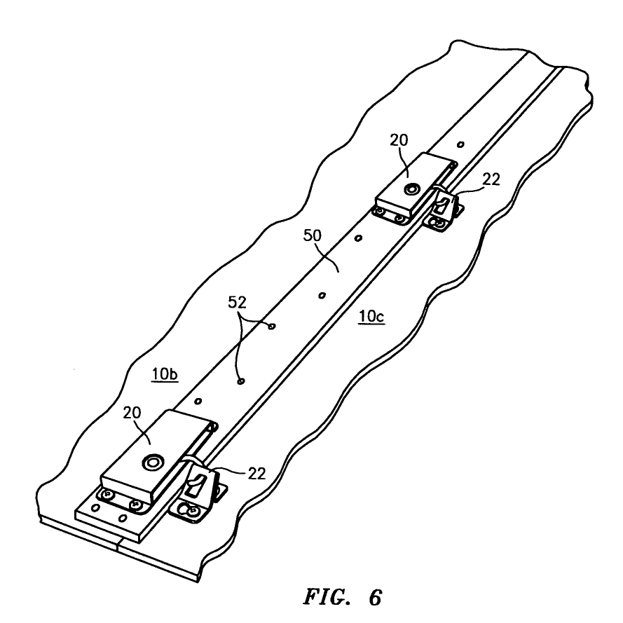

In FIG. 6 a pair of shutters 10b and 10c are arranged in abutting relationship in a common plane with a batten 50 positioned over the joint between the shutters. The batten 50 is shown mounted on the shutter 10b by means of screws 52, 52. A pair latching devices 20, 20 spaced along the batten 50 co-operate with anchor devices 22, 22 to secure the shutters 10b and 10c in firm abutting and sealed relationship, the batten 50 being urged in a perpendicular direction for firm engagement with the shutter 10c by the aforementioned derivative force perpendicular to the shutters.

Another aspect of the present invention resides in the provision of an installation method comprising the steps of providing a shutter with at least one latching device mounted thereon so as to project beyond the edge in a latching operation. The latching device has a rearwardly exposed operation means and the shutter has a small opening aligned with the operating means. An anchor device on an adjacent trim portion cooperates with the latching device. The shutter is positioned over a window or the like to be protected and the operating means is actuated from inside the shutter through the small aligned opening, the latching device thus engaging the anchor device and securing the shutter in place.

A further step in the method resides in proving a vertical support means for temporarily holding the shutter while the latching device is engaged with the anchor device.

Still another aspect of the invention, resides in the one man procedure with the installer passing the shutter outwardly through an open window or the like and thereafter positioning and securing the same in place as aforesaid.

1. A shutter and fastener system for use in areas subject to hurricanes and the like; said system comprising a shutter dimensioned to cover an opening such as a window and having at least two spaced apart edge portions with window trim or the like adjacent thereto, at least two fastener mechanisms each comprising cooperating latching and anchor devices, one device mounted on an edge portion of a shutter and the other on an adjacent trim portion with neither device projecting beyond the adjacent shutter edge in its unlatched condition, each latching device however projecting beyond the adjacent shutter edge to engage its cooperating anchor device and exert a strong latching force therebetween during a latching operation, and means on one of said devices also exerting a force perpendicular to the shutter in a direction urging the same tightly against its adjacent trim during a latching operation.

2. A shutter and fastener system as set forth in claim 1 wherein said latching force is in a direction substantially parallel to the face of the shutter, and wherein one of said devices includes a means for converting a portion of said parallel latching force to the aforesaid perpendicular force urging the shutter against the trim.

3. A shutter and fastener system as set forth in claim 1 wherein the latching element exerts a retractive force of as much as 500 pounds on its cooperating anchor device in a direction parallel to the shutter face.

4. A shutter and fastener system as set forth in claim 2 wherein the converting means providing the perpendicular force takes the form of an inclined surface on the anchor device which is engaged by the latching element during its retractive latching operation.

5. A shutter and fastener system as set forth in claim 2 wherein the latching element is a pivotally mounted generally S shaped device having a latching hook at its free end, and wherein the anchor device includes a slotted member adapted to receive the latching hook.

6. A shutter and fastener system as set forth in claim 5 wherein the slot in the anchor member is inclined to provide a perpendicular force urging the shutter into engagement with the trim, the latching hook exerting a pulling force on the slot edge surface.

7. A shutter and fastener system as set forth in claim 6 wherein the latching element is eccentrically mounted for pivotal movement to provide for a pulling force on the anchor member during its latching movement.

8. A shutter and fastener system as set forth in claim 1 wherein the shutter takes a generally rectangular configuration, and wherein at least four (4) fasteners are provided in a generally rectangular arrangement corresponding to the configuration of the shutter.

9. A fastener mechanism for use on hurricane shutters and the like comprising cooperating latching and anchor devices adapted to be mounted one on an edge portion of a shutter and the other on an adjacent trim portion, neither device projecting beyond the adjacent shutter edge in its unlatched condition, the latching device exerting a strong latching force substantially parallel to the face of the shutter on engagement with the anchor device, and a means on one of said devices converting at least a portion of said latching force to a resultant force perpendicular thereto for urging a shutter tightly against its adjacent trim portion.

10. A fastener as set forth in claim 9 wherein the latching device includes an eccentric actuator which causes the device to pull with as much as a 500 pound force on the anchor device.

11. A fastener as set forth in claim 10 wherein the latching device is a spring like member with a latching hook at its free end, and wherein the anchor device has an inclined surface engaged by the hook in a pulling action to exert both a force parallel to the face of a shutter and a force in a direction perpendicular to and toward the shutter.

12. A fastener as set forth in claim 11 wherein said inclined surface is provided in the form of a receiving member with an inclined slot for the latching hook.

13. A fastener as set forth in claim 9 wherein the latching device has a rearwardly exposed operating means.

14. A fastener as set forth in claim 13 wherein the latching device has a socket type operating means.

15. A fastener as set forth in claim 14 wherein the latching device has both front and rearwardly exposed operating means.

16. A hurricane shutter installation method comprising the steps of providing a shutter with at least one latching device mounted thereon near an edge so as to project beyond the edge in a latching operation, the latching device having a rearwardly exposed operating means and the shutter having a small opening aligned with the operating means, providing an anchor device on an adjacent trim portion for co-operation with the latching device, positioning the shutter over a window or the like to be protected, and accessing said operating means from the inside of the shutter through said aligned opening and actuating the same to cause the latching device to engage the anchor device and thus secure the shutter in place.

17. A hurricane shutter installation method as set forth in claim 16 wherein co-operating vertical support means are provided on the shutter at a top portion and an adjacent trim portion, and wherein said means are engaged with each other to hold the shutter temporarily while the latching device is engaged with the anchor device.

18. A hurricane shutter installation method as set forth in claim 16 wherein a one man procedure is followed with the installer passing the shutter outwardly through an open window or the like and then positioning and securing the same in place as aforesaid.

19. A hurricane shutter installation method as set forth in claim 16 wherein operating sockets are provide on both the front and rear surfaces of the latching device, and wherein a first installer positions the shutter from the outside with a second installer operating the latching device from the inside.
